(19) United States
(12) Patent Application Publication
(10) Pub. No.: US 2025/0240702 A1
(43) Pub. Date: Jul. 24, 2025

(54) SYSTEMS AND METHODS FOR USING EXTERNAL IDENTIFIERS FOR ROUTING

(71) Applicant: Verizon Patent and Licensing Inc., Basking Ridge, NJ (US)

(72) Inventors: Bharadwaj Vemuri, Jersey City, NJ (US); Taussif Khan, Martinsville, NJ (US); Axel Hallo de Wolf, Whippany, NJ (US)

(21) Appl. No.: 18/416,097

(22) Filed: Jan. 18, 2024

(51) Int. Cl. H04W 40/28; H04W 40/24

(52) U.S. Cl. CPC H04W 40/28; H04W 40/248

(57) ABSTRACT

A device may include a processor. The processor may be configured to receive, via a wireless connection, from an application server that provided a source external identifier to a source User Equipment device (UE), a routing request that includes data and an identifier for a destination UE. The processor may also be configured to look up a target external identifier for the destination UE; and route the data to a target application server that issued the target external identifier.

### BACKGROUND INFORMATION

A cellular network must be able to uniquely identify (e.g., identify, without ambiguity, what is recognized as one item among all other recognized items) each of the Internet-of-Things (IoT) devices that are wirelessly attached to the network, in order to manage them. It is necessary, therefore, for the devices to have unique identifiers. Given that there is a limited amount of unique telephone numbers and given that the expected number of IoT devices will be extremely large, a cellular network may be unable to use telephone numbers as unique device identifiers.

### BRIEF DESCRIPTION OF THE DRAWINGS

FIGS. 1A and 1B illustrate an overview of a system for using external identifiers (EXIDs) for routing.

FIG. 2 illustrates an exemplary network environment in which a system described herein may be implemented.

FIG. 3 depicts example components of a User Equipment device (UE) according to an implementation.

FIG. 4 illustrates example components of an external identifier (EXID) system according to an implementation.

FIG. 5 illustrates example records in an EXID database (DB), according to an implementation.

FIG. 6 is a flow diagram of an example process associated with registering a network, an EXID, and/or a UE ID at an EXID system, according to an implementation.

FIG. 7 illustrates example messages that are exchanged by a system during registration of a network, an EXID, and/or a UE ID at an EXID system according to an implementation.

FIG. 8 is a flow diagram of an example process associated with a system for using EXIDs for routing, according to an implementation.

FIG. 9 illustrates example messages that are exchanged by a system for using EXIDs for routing, according to an implementation.

FIG. 10 depicts example functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID).

As used herein, the term “session” may refer to a series of communications, of a limited duration, between two endpoints (e.g., two applications). When a session is established between an application and a network or a network slice, the session is established between the application and another application/server hosted by the network or the network slice. Similarly, if a session is established between a device and a network slice or a network, the session is established between an application on the device and another application on either the network slice or the network.

Systems and methods described herein relate to using external identifiers for routing messages, notifications, etc. More particularly, by using external identifiers, a system may route messages, notifications, and/or session handles without relying on “telephone numbers” or their equivalents. As used herein, the term “external identifier” (EXID) may refer to an alpha-numeric identifier. Examples of EXIDs include user-id@blah.com, “stewart.crash.com,” “hula.media.smart.com,” where the domain names are “blah.com,” “crash.com,” and “smart.com,” respectively. EXID is described below in greater detail.

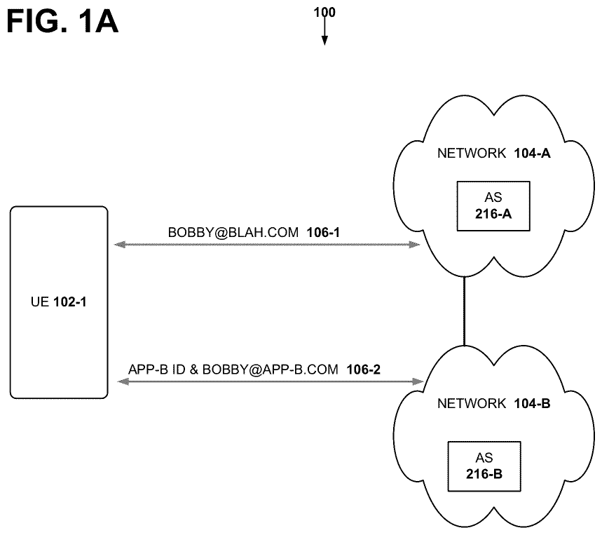

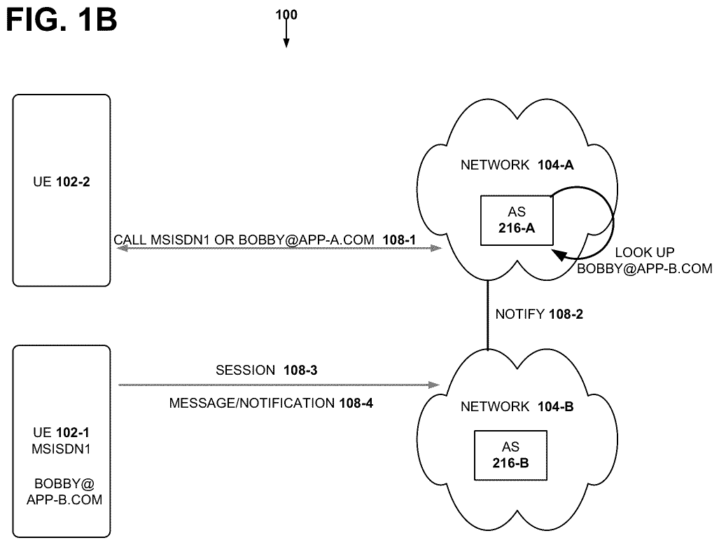

FIGS. 1A and 1B are overviews of a system 100 for using EXIDs for routing. As shown in FIG. 1A, system 100 may include a User Equipment device (UE) 102-1 and components of network 104-A and network 104-B, such as application server (AS) 216-A and AS 216-B. Networks 104-A and 104-B may be federated, at least for routing based on EXIDs that are associated with AS 216-A and AS-216-B in networks 104-A and 104-B. Assume that UE 102-1 is implemented as an Internet-of-Things (IoT) device. Also, assume that UE 102-1 is subscribed to network 104-A. In network 104-A, calls (e.g., voice over Internet Protocol (VOIP) calls or videoconference calls) to UE 102-1 may be handled by AS 216-A. Furthermore, assume that UE 102-1 has an EXID of BOBBY@BLAH.COM.

As shown in FIG. 1A, during its interactions with network 104-A, UE 102-1 registers BOBBY@BLAH.COM with components of system 100 in network 104-A. Because networks 104-A and 104-B are federated for EXID-based routing, network 104-A may indicate to network 104-B that BOBBY@BLAH.COM is registered at network 104-A. As further shown, UE 102-1 then obtains an EXID of BOBBY@APP-B.COM at AS 216-B in network 104-B (arrow 106-2). When UE 102-1 obtains BOBBY@APP-B.COM, system 100 may cause network 104-B to forward the EXID to network 104-A. Consequently, networks 104-A and 104-B both include information about EXIDs BOBBY@BLAH.COM and BOBBY@APP-B.COM.

FIG. 1B illustrates system 100 using EXIDs for routing a message or a notification to UE 102-1 without relying on the Mobile Station International Subscriber Directory Number (MSISDN) associated with UE 102-1. Assume that US 102-1 is not wirelessly connected to network 104-1 and that a UE 102-2 is in possession of an MSISDN of UE 102-1 (MSISDN 1) or the EXID BOBBY@APP-A.COM. Suppose that UE 102-2, which is also registered at network 104-A, calls UE 102-1 by sending a call request with either an MSISDN 1 of UE 102-1 or BOBBY@APP-A.COM (arrow 108-1). That is, UE 102-2 may attempt to contact UE 102-1 via AS 216-A. Although network 104-A is unable to connect UE 102-2 to UE 102-1 via AS 216-A (because UE 102-1 is not connected to network 104-A), network 104-A may use either the MSISDN 1 or BOBBY@APP-A.COM provided by UE 102-2 to obtain other EXIDs of UE 102-1. More specifically, network 104-1 may use either MSISDN 1 or BOBBY@APP-A.COM to infer the EXID of BOBBY@APP-B.COM for UE 102-1 at AS 216-B. Upon determining that UE 102-1 has the EXID of BOBBY@APP-B.COM, network 104-A may route a notification or a message to BOBBY@APP-B.COM at AS 216-B in network 104-B (arrow 108-2).

In scenarios where AS 216-B is capable of exchanging session data with AS 216-A, network 104-A may convey a message from UE 102-2 to BOBBYAPP-B.COM at AS 216-B (108-2). When UE 102-1 establishes a session via AS 216-B (arrow 108-3), UE 102-1 may access the notification or the message from UE 102-2 (108-4) via AS 216-B. In FIGS. 1A and 1B, by using EXIDs, system 100 may route calls and/or messages from UEs 102 without necessarily relying on MSISDNs, although, in some scenarios, system 100 may still use MSISDNs, if available, for routing.

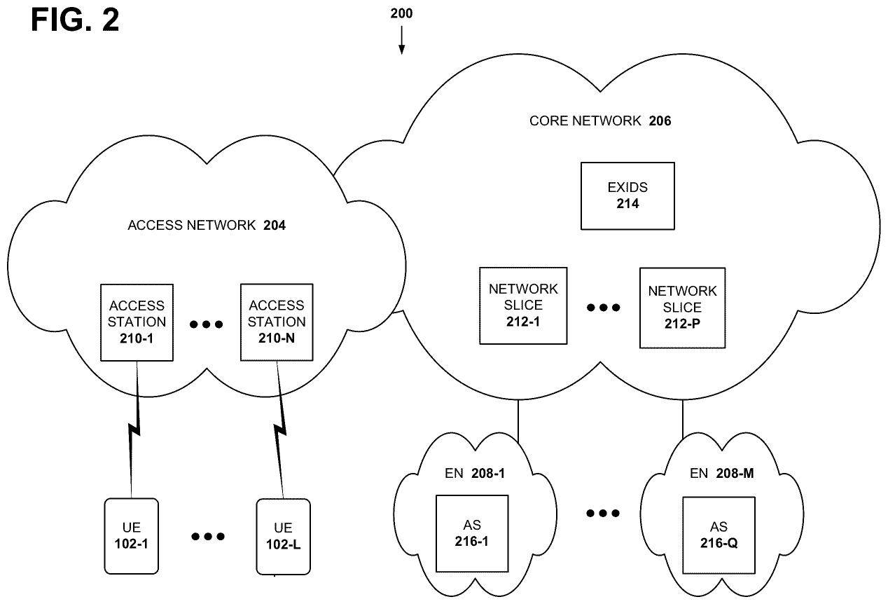

FIG. 2 illustrates an exemplary network environment 200 in which system 100 may be implemented. As shown, environment 200 may include UEs 102-1 through 102-L (collectively referred to as UEs 102 and generically referred to as UE 102), an access network 204, a core network 206, and external networks (ENs) 208-1 through 208-M (collectively referred to as external networks 208 and generically as external network 208). Access network 204 and core network 206 may be part of provider network 104 (shown in FIGS. 1A and 1B as either network 104-1 or 104-2 but not shown in FIG. 2). Network 104-2 may be implemented as either a provider network or external network 208.

UEs 102 may include wireless communication devices capable of Fifth Generation (5G) New Radio (NR) communication. Some UEs 102 may include Fourth Generation (4G) (e.g., Long-Term Evolution (LTE)) communication capabilities or a combination of 5G and 4G communication capabilities (e.g., Evolved-Universal Terrestrial Radio Access-New Radio-Dual connectivity (EN-DC) capability). Examples of UE 102 include: a Fixed Wireless Access (FWA) device; a Customer Premises Equipment (CPE) device; a smart phone; a tablet device; a wearable computer device (e.g., a smart watch); a global positioning system (GPS) device; a laptop computer; a media playing device; a portable gaming system; an autonomous vehicle navigation system; a sensor, such as a pressure sensor; or an IoT device. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

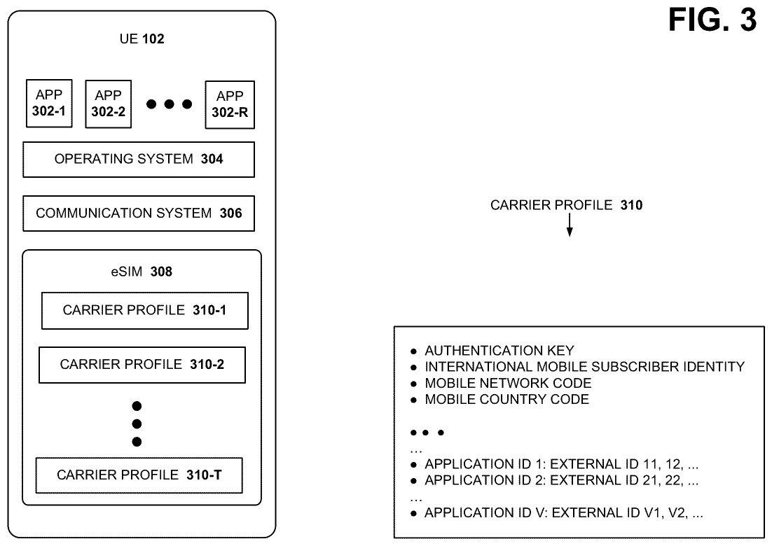

Each UE 102 may have an EXID, either assigned by network 104, a UE retailer, or a UE manufacturer. In addition, UE 102 may include one or more applications 302 (see FIG. 3) that receive services from one or more application servers (ASs) in network slices 212, external networks 208, or core network 206. In some implementations, UE 102 may receive EXIDs for its applications from network 104. UE 102 may store EXIDs and UE ID. After UE 102 obtains an EXID for an application 302, UE 102 may receive the corresponding network service from AS 216 in network 104.

Access network 204 may allow UEs 102 to access core network 206. To do so, access network 204 may establish and maintain, with participation from UEs 102, an over-the-air channel with UEs 102; and maintain backhaul channels with core network 206. Access network 204 may relay information through such channels, from UEs 102 to core network 206 and vice versa. Access network 204 may include an LTE radio network and/or a 5G NR network, or another advanced radio network. These networks may include many central units (CUs), distributed units (DUs), radio units (RUs), and wireless stations, some of which are illustrated in FIG. 2 as access stations 210-1 through 210-N, for establishing and maintaining over-the-air channel with UEs 102. In some implementations, access station 210 may include a 4G, 5G, or another type of base station (e.g., eNB, gNB, etc.) that comprises one or more radio frequency (RF) transceivers. In some implementations, access station 210 may be part of an evolved Universal Mobile Telecommunications Service (UMTS) Terrestrial Radio Access Network (eUTRAN).

Core network 206 may include one or more devices and network components for providing communication services to UEs 102. For example, core network 206 may permit UEs 102 to attach to network 104, establish sessions with devices in network 104, and/or receive services from network 104 (e.g., receive content, access the Internet, conduct video conferences with other UEs 102 attached to network 104). To deliver services, core network 206 may interface with other networks, such as external networks 208. To render these services and to perform the core functions of network 104, core network 206 may include 5G core network components or 4G (e.g., LTE) core network components.

As further shown, core network 206 may include one or more network slices 212-1 to 212-P (collectively referred to network slices 212 and generically referred to as network slice 212). Depending on the implementation, network slices 212 may be implemented within other networks, such as access network 204 and/or external networks 208. Access network 204, core network 206, and external networks 208 may include multiple instances of network slices 212. Each network slice 212 may be instantiated as a result of network slicing, which involves a form of virtual network architecture that enables multiple logical networks to be implemented on top of a shared physical network infrastructure using software defined networking (SDN) and/or network function virtualization (NFV). Each logical network, referred to as a “network slice,” may encompass an end-to-end virtual network with dedicated storage and/or computational resources that include access network components, clouds, transport components, Central Processing Unit (CPU) cycles, memory, etc. Furthermore, each network slice 212 may be configured to meet a different set of requirements and may be associated with a particular Quality-of-Service (QOS) Class Identifier (QCI), 5G QOS Identifier (5Q1), and/or a particular group of enterprise customers associated with communication devices.

Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example. Each network slice 212 may be associated with an identifier, herein referred to as a Single Network Slice Selection Assistance Information (S-NSSAI) and/or a network slice instance ID. Many components in core network 206 may manage S-NSSAIs (or simply NSSAI).

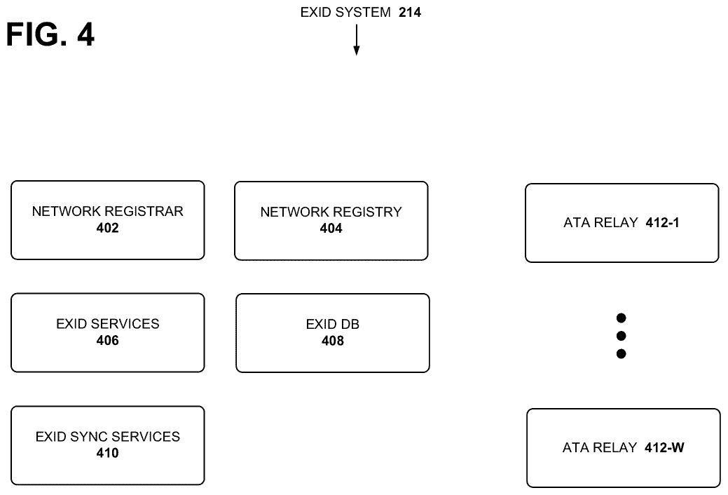

As further shown, core network 206 may also include an EXID system 214. EXID system 214 may permit other networks that include their own EXID systems to register with EXID system 214. In addition, EXID system 214 may permit UEs 102 and/or ASs 216 to register UE IDs or EXIDs at EXID system 214. Furthermore, EXID system 214 may route messages, notifications, or session handles (e.g., calls) to ASs 216 in networks that are registered at EXID system 214. EXID system 214 may synchronize its EXID information with EXID systems 214 in networks that are registered at EXID system 214. EXID system 214 is described in greater detail with reference to FIG. 4.

External networks 208 may include one or more networks connected to core network 206. In some implementations, a particular external network 208 may be associated with a data network name (DNN) in 5G and/or an Access Point Name (APN) in 4G. UE 102 may request a connection to external network 208 using a DNN or APN. Each external network 208 may include and/or be connected to a local area network (LAN), a wide area network (WAN), a metropolitan area network (MAN), an autonomous system on the Internet, an optical network, a cable television network, a satellite network, another wireless network (e.g., a Code Division Multiple Access (CDMA) network, a general packet radio service (GPRS) network, and/or an LTE network), a telephone network (e.g., the Public Switched Telephone Network (PSTN) or a cellular network), an intranet, an ad hoc network, or a combination of networks.

Depending on the implementation, each external network 208 may have its own identifier. For example, if external network 208 is implemented as a cellular network, external network may have an PLMN ID. Such an external network 208 may be implemented to include EXID system 214 of its own (not shown) and operate as network 104 and operate as part of a federated system of networks 104.

As further shown, external network 208 may include one or more ASs 216 (also referred to as applications). AS 216 may render services to applications running on UEs 102 and may establish communication sessions with UEs 102 via core network 206 or via another path. In some implementations, when UE 102 attempts to install and/or run a client application (e.g., application 302) for the AS 216, AS 216 may issue an EXID to UE 102 and register the EXID at EXID system 214. The client application (herein simply referred to as application 302) may use the EXID from AS 216 to receive its services from AS 216.

AS 216 may include various mechanisms for notifying EXID system 214 when application 302 on UE 102 connects to AS 216, attempts to receive services from AS 216, sends messages to AS 216, and/or establishes a session via AS 216. In one implementation, AS 216 may use a callback application programming interface (API) provided by EXID system 214. Upon receipt of a callback from AS 216, EXID system 214 may route a notification, a message, or a session handle associated with UE 102 to other ASs 216 in networks 104, by using EXIDs.

For clarity, FIG. 2 does not show all components that may be included in network environment 200 (e.g., routers, bridges, wireless access point, additional networks, additional access stations 210, data centers, portals, etc.). Depending on the implementation, network environment 200 may include additional, fewer, different, or a different arrangement of components than those illustrated in FIG. 2. Furthermore, in different implementations, the configuration of network environment 200 may be different.

FIG. 3 depicts example components of a UE 102 according to an implementation. As shown, UE 102 may include applications 302-1 through 302-R, an operating system 304, a communication system 306, and an embedded Subscriber Identity Module (eSIM) 308. Depending on the implementation, UE 102 may comprise additional components, fewer components, or different components than those illustrated in FIG. 3.

Application 302 may include one or more software programs that run on UE 102. Application 302 may operate in conjunction with another program, such as an application function (AF) or AS 216, on network 104, on network slice 212, or on external network 208. Application 302 may include or be provisioned with an EXID or may obtain an EXID from AS 216. When application 302 has an EXID, application 302 may store the EXID in eSIM 308, as part of a carrier profile associated with network 104. Application 302 may retrieve a specific EXID from eSIM 308 and use the EXID to receive services from the corresponding AS 216 in network 104 upon establishing a connection or a session with the AS 216.

In some implementations, application 302 may be capable of communicating with other applications 302 on other UEs 102 via the AS 216 and/or EXID system 216. In particular, when application 302 establishes a connection to AS 216, application 302 may provide a message, a notification, a call request, an EXID of a destination endpoint and/or a UE ID of a destination UE to AS 216. In response, AS 216 may use a callback API provided by EXID system 214 to pass the message, the notification, the UE ID of the source UE 102 (e.g., the UE 102 sending the message), the EXID associated with the source application 302, the UE ID of the destination UE 102, and/or the EXID associated with the destination application (collectively referred to simply as data). EXID system 214 may then route the data to endpoints represented by various EXIDs associated applications 302 on the destination UE 102.

Operating system 304 may manage applications 302, services, memory, and/or other resources on UE 102. Additionally, operating system 304 may relay connection requests from application 302 to communication system 306 and relay messages/notifications that arrive at communication system 306 from network 104 to application 302. Operating system 306 may enforce security requirements and prevent application 302 from passing some types of application-related information to other components in UE 102, such as communication system 306.

Communication system 306 may perform communication-related functions, including establishing connections between UE 102 and network 104, delivering messages from/to UE 102 to/from network 104, performing modulation/demodulation, performing signal processing, etc. When communication system 306 receives a connection request from application 302 via operating system 304, communication system 306 may establish a Protocol Data Unit (PDU) session with network 104. During the PDU session establishment, communication system 306 may forward the UE ID (e.g., MSISDN) and/or an EXID of UE 102 to core network 206. In response, core network 206 may notify EXID system 214, passing the UE ID, the EXID or the UE ID, a message, a notification, or a session handle to EXID system 214. In some implementations, AS 216 may pass the data to EXID system 214 when UE 102 establishes a session with AS 216.

eSIM 308 may include carrier profiles 310-1 through 310-T. Each carrier profile 310 may include information that may be used by communication system 306 and/or application 302 to establish a connection with a particular network 104 and/or to receive services from the particular network 104. As further shown, each carrier profile 310 may include an authentication key, an International Mobile Subscriber Identity (IMSI) or other identifiers associated with the UE 102 (e.g., an MSISDN, a Subscription Permanent Identifier (SUPI), a Subscription Concealed Identifier (SUCI), an International Mobile Equipment Identity (IMEI), etc.), a mobile network code, a mobile country code, and one or more pairs of application ID (e.g., the ID of an application 302 that is hosted by UE 102 and the corresponding EXIDs for one or more users of the application 302. Additionally, although not shown in FIG. 3B, carrier profile 310 may include an EXID that is associated with the UE 102 but not associated with a particular user and application 302 hosted by the UE 102.

FIG. 4 illustrates example components of EXID system 214, according to an implementation. As shown, EXID system 214 may include a network registrar 402, a network registry 404, an EXID services 406, an EXID database (DB) 408, an EXID sync services 410, and app-to-app (ATA) relays 412-1 through 412-W. Depending on the implementation, EXID system 214 may include additional, fewer, and/or different components than those illustrated in FIG. 4. Network registrar 402 may receive requests from other networks to register at EXID system 214 and register the requesting networks. Furthermore, the registrar 402 may register the network 104 hosting the registrar 402 at other registrars 402 in other networks 104.

When registering a network 104, network registrar 402 may receive registration information from the registrant network 104 and store the received information at network registry 404. The received registration information may include, for example, a network ID (e.g., PLMN ID), security information (e.g., authentication key, access level, etc.), services the registering network may access, etc. If the registration is successful, network registrar 402 may send an acknowledgment message to the registrant network 104. The acknowledgment message may include, for example, authentication information for accessing network 104.

In addition to handling registration requests, network registrar 402 may distribute registration information stored at network registry 404. More specifically, network registrar 402 may send contents of network registry 404 to each EXID system 214 in registered networks (e.g., external network 208 or provider network 104) so that the network registry 404 is synchronized with other network registries 404 of the registered networks. Conversely, when network registrar 404 receives a request to synchronize network registry 404, network registrar 402 may accept the registry information provided in the request and use the information to synchronize its network registry 404 with the registry of the requesting network 104. Network registry 404 may store registration information for networks 104 that are registered at EXID system 214.

EXID services 406 may manage requests from core network 206 and/or AS 216 to register and/or deregister EXIDs. When EXID services 406 receives an EXID registration request, EXID services 406 may store, in EXID DB 408, an EXID (also referred to as a primary EXID), the UE ID, and/or a secondary EXID provided in the request. In one implementation, EXID services 406 may be implemented via API calls. In such an implementation, a network component (e.g., a network device or an element in core network 206 or AS 216) may make a registration request API call that provides the primary EXID, the UE ID, the application ID, and/or the secondary EXID to EXID services 406. Upon receipt of the registration request API call, EXID services 406 may store the primary EXID, the UE ID, the application ID, and/or the secondary EXID in EXID DB 408. Similarly, when EXID services 406 receives a de-registration request API call, EXID services 406 may remove the EXID from EXID DB 408, along with other information stored with the EXID.

In addition to handling registration/deregistration requests, EXID services 406 may render routing services for calls, messages, and/or notifications based on EXIDs. In one implementation, the routing service may be rendered via API callbacks. For example, EXID services 406 may begin its routing service when EXID services 406 receives a routing request API call from a network component (e.g., a component in core network 206 or AS 216 in external network 208). More specifically, when EXID services 406 receives the routing request from a source AS 216, EXID services 406 may use the IDs provided in the request to deliver a notification, a message, or a session handle to target ASs 216. The IDs included in the request may include a UE ID or an EXID of a source UE 102 on whose behalf the source AS 216 is making the request, a UE ID or an EXID of a destination UE 102, and application IDs of the source AS 216 and destination AS 216. When EXID services 406 receives the IDs, EXID services 406 may use the destination ID to look up all related IDs (herein referred to as target IDs) that are associated with the destination ID in EXID DB 408. For each of different pairs of <source ID, the target ID, EXID>, EXID services 406 may pass, to a corresponding app-to-app (ATA) relay 412, a message, a notification, or a session handle from the source. EXID DB 408 may store records that are associated with UE IDs and EXIDs.

EXID sync services 410 may synchronize EXID DBs 408 in the networks identified by network registry 404. ATA relay 412 may include an API or a reference to the API for conveying a message, a notification, or a session handle from a source AS 216 to a target AS 216. The source AS 216 may be associated with a source UE ID or a source EXID; and the target AS 216 may be associated with a target UE ID or a target EXID. As an example, assume that UE 102 (with a source EXID/UE ID) establishes a session with a source AS 216-1, specifying an EXID of a destination UE 102 (the destination EXID). When the source AS 216-1 invokes EXID services 406 (passing the source EXID/UE ID, the destination UE ID/EXID, a session handle, a message, and/or a notification associated with the source UE 102 to EXID services 406), EXID services 406 may perform a lookup of the destination EXID/UE ID in EXID DB 408 to determine target EXIDs/UE IDs. Target EXIDs/UE IDs are additional IDs of the destination UE 102 or EXIIDs associated with the users of applications 302 hosted by the destination UE 102. For each of different pairs of <source EXID/UE ID, a target EXID/UE ID>, EXID services 406 may identify a corresponding ATA relay 412 by accessing the EXID DB 408. Next, EXID services 406 may pass the source EXID/UE ID, the session handle, the message, or the notification to each ATA relay 412 corresponding to the pair <source UE ID/EXID, target UE ID/EXID>. For example, if a destination EXID is BOBBY@BLAH.COM, EXID services 406 may send a notification to all target EXIDs/UE IDs associated with the destination EXID via the corresponding ATA relays 412.

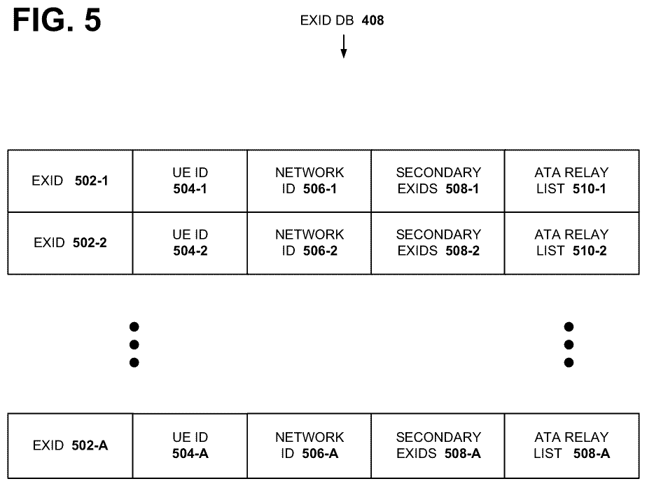

FIG. 5 illustrates example records in EXID DB 408, according to an implementation. As shown, each record may include an EXID field 502, a UE ID field 504, a network ID field 506, a secondary EXIDs field 508, and ATA relay list field 510. Depending on the implementation, records 500 in EXID DB 408 may include additional, fewer, or different fields than those illustrated in FIG. 5. For example, in one implementation where EXID services 406 directly handle messaging between sessions with different ASs 216, EXID system 214 may not include any ATA relays 412 and therefore, each of the records in EXID DB 408 may not include ATA relay list field 510. In another example, in implementations where EXID system 214 tracks whether UE 102 is engaged in a live session, each of the records in EXID DB 408 may include a field for indicating whether a UE 102 is currently conducting a session with an AS 216.

EXID field 502 may store an external ID that identifies and is associated with UE 102. UE ID field 504 may include a UE ID that identifies UE 102 (other than the EXID in EXID field 502). Network ID field 506 may store an ID of the network (e.g., a PLMN ID of provider network 104 that uses the UE ID to render its communication services). EXID services 406 may store an EXID in EXID field 502, a UE ID in UE ID field 504, and a network ID in network ID field 506 when either core network 206 or AS 216 registers the EXID at EXID system 214 via an API call.

Secondary EXIDs field 508 may store EXIDs that are associated with users of applications 302 and ASs 216. EXID services 406 may store an EXID in secondary XID field 408 when the secondary EXID/UE ID is provided along with the EXID being registered. ATA relay list field 510 may include a list of addresses or references to ATA relays 412, where each ATA relay 412 is configured to forward a message, a session handle, or a notification from the AS 216 associated with the EXID of EXID field 502 to AS 216 associated with one of the secondary EXIDs in secondary EXIDs field 508. During the relay, the EXIDs may serve as the endpoints of the routing (e.g., the source and the destination).

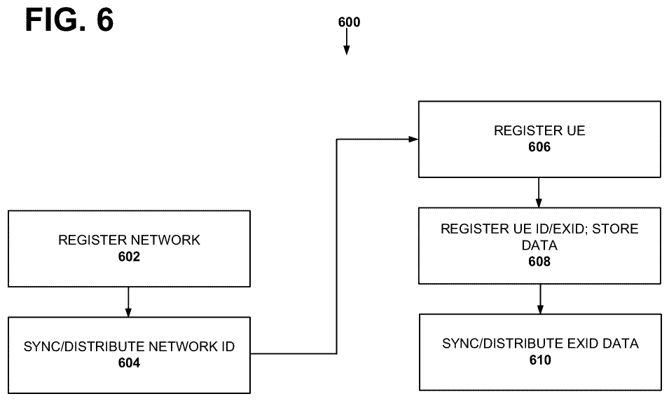

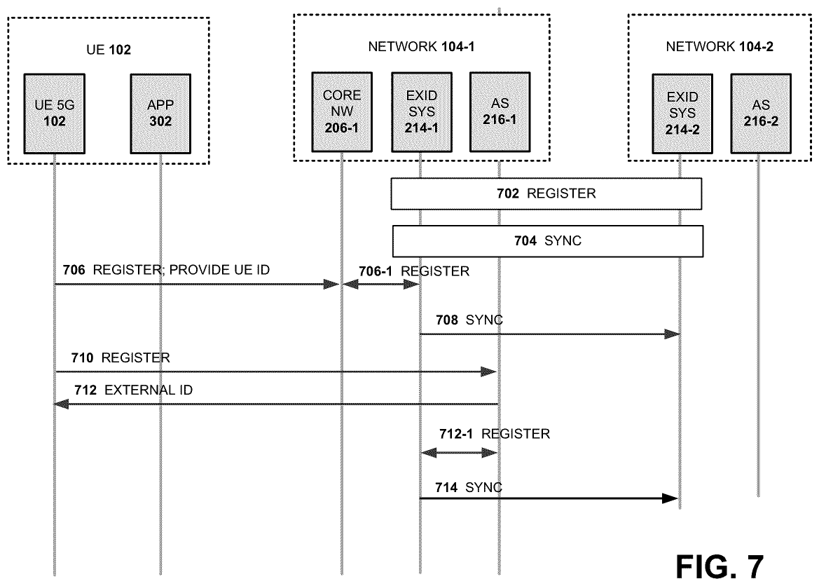

FIG. 6 is a flow diagram of an example process 600 associated with registering a network, an EXID, and/or a UE ID at EXID system 100, according to an implementation. FIG. 7 shows example messages that are exchanged by system 100 during process 600. Process 600 may be performed by components of UEs 102 and networks 104 (e.g., network 104-1 and network 104-2 in FIG. 7). As shown, process 600 may include EXID system 214 registering its host network 104 at another EXID system 214 (block 602; box 702 in FIG. 7). The registrant EXID system 214 may include in the registration request an ID of its host network.

Process 600 may further include EXID system 214 distributing information in network registry 404 to other registries 404 of the registered networks 104 or synchronizing network registry 404 to registries 404 of other EXID systems 214 in registered networks 214 (block 604; block 704). After the distribution/synchronization, each of EXID systems 214 of the registered networks 404 may have a list of the registered networks.

Process 600 may further include registering UE 102 at network 104 or registering a user of application 302 on UE 102 at AS 216 on network 104 (block 606). For example, as shown in FIG. 7, UE 102 may register at core network 206-1 in network 104-1, providing its UE ID to core network 206-1 (block 606; arrow 706). In turn, core network 206-1 which may be configured to coordinate with EXID system 214, may pass the UE ID to EXID system 214 for registration (block 608; arrow 706-1). In response, EXID system 214 may store the UE ID and a network ID (e.g., ID of network 104-1) in a record in EXID DB 408 of EXID system 214 (block 608).

In another example, as shown in FIG. 7, a user of application 302 on UE 102 may register at AS 216-1 in network 104-1 (block 606; arrow 710). In turn, AS 216 may allocate and provide an EXID associated with the user of application 302 to UE 102 (arrow 712). In response, UE 102 may store the EXID and the application ID in carrier profile 310 (corresponding to network 104-1) in eSIM 308. Furthermore, AS 216-1 may register the EXID at EXID system 214 (block 608; arrow 712-1), passing via a callback the relevant registration information (e.g., an application ID, a UE ID, a primary EXID, the EX ID to be registered, etc.). In some implementations, AS 216 may also pass one or more ATA relays 412 or references to ATA relays 412. EXID system 214 may then store the registration information in EXID DB 408 (block 608).

Process 600 may further include EXID system 214 distributing its EXID data in EXID DB 408 to EXID DBs 408 in other EXID systems 214 in the registered networks or synchronizing its EXID DB 408 with other EXID DBs 408 in the other EXID systems 214 (block 610). For example, EXID system 214-1 may distribute a UE ID and its related data to EXID system 214-2 in network 104-2 (arrow 708). In another example, EXID system 214-1 may distribute an EXID and related data to EXID system 214-2 in network 104-2 (arrow 714). When two EXID DBs 408 in different EXID systems 214 in different networks 104 are synchronized, the two EXID DBs 408 may include the same or similar data.

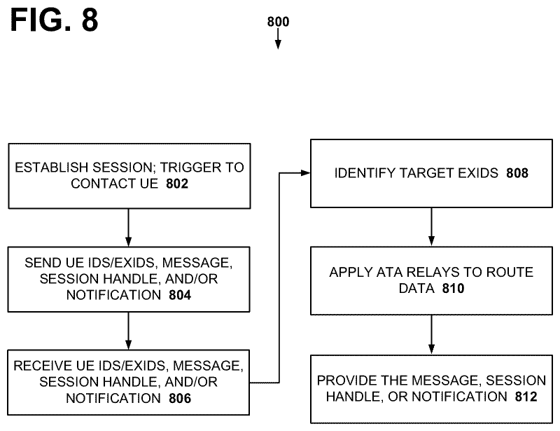

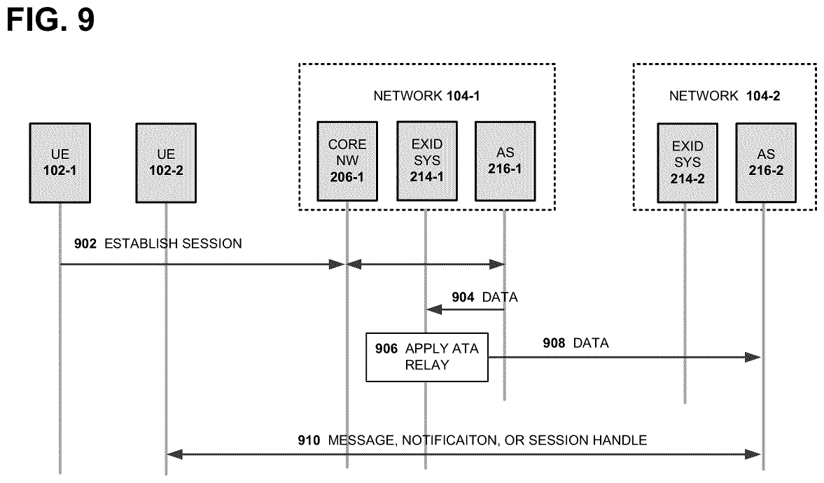

FIG. 8 is a flow diagram of an example process 800 associated with system 100, according to an implementation. FIG. 9 illustrates example messages that are exchanged by system 100 during process 800. Process 800 may be performed by components of UEs 102 (e.g., UEs 102-1 and 102-2 in FIG. 9) and networks 104 (e.g., network 104-1 and network 104-2 in FIG. 9). As shown, process 800 may include a source UE 102 (or a source application 302 on the source UE 102) establishing a session with AS 216 (referred to as source AS 216) via core network 206 (block 802). For example, as shown in FIG. 9, UE 102-1 may establish a session with AS 216-1 via core network 206-1 (arrow 902). Upon establishment of the session, AS 216 may be triggered to contact another UE 102 (herein referred to as a destination UE 102) (block 802). The trigger may be an indication from the source application 302/UE 102 to have a communication session with a destination application 302 on the destination UE 102; a request from the source application 302/UE 102 to send a notification to the destination application 302/UE 102; or to send a particular message to the destination application 302/UE 102-2.

In response to the trigger, AS 216 may send the UE ID of the source UE 102, the EXID of the source application 302, the UE ID of the destination UE 102, and the EXID associated with a user of the destination application 302 to EXID system 214 (block 804). In addition, AS 216 may send session a handle, a message, and/or a notification (to be conveyed from the source UE 102/application 302 to the destination UE 102/application 302) to EXID system 214 (block 802). EXID system 214 may receive the data (block 806). For example, AS 216-1 may send to EXID system 214-1 the UE ID of UE 102-1, an EXID associated with application 302 on UE 102-1, the UE ID of UE 102-2, the EXID associated with an application 302 on UE 102-2, a notification, a message, or a session handle (arrow 904). EXID system 214-1 may receive the data from AS 216-1.

Process 800 may further include identifying target UE IDs or target EXIDs (block 808). When EXID system 214 receives the UE IDs and/or EXIDs (e.g., via a callback), EXID system 214 may use the destination UE ID or the destination EXID to identify one or more records whose contents in EXID field 502 and/or UE ID field 504 match the destination UE ID/EXID. Next, EXID system 214 may obtain the contents of secondary EXIDs field 508, which includes the target EXIDs. The target EXIDs may include EXIDs that are associated with users of applications 302 on the destination UE 102.

Process 800 may further include applying ATA relays 412 (block 810; block 906). When EXID system 214 obtains the target EXIDs, EXID system 214 may form pairs of <source UE ID/EXID, target UE ID/EXID> from different combinations of the source UE ID/EXID and target UE ID/EXID. Next, for each of the pairs, EXID system 214 may identify a corresponding ATA relay 412 (if it exists) and apply the corresponding ATA relay 412. In addition, EXID system 214 may apply the ATA relay 412 corresponding to <source UE ID/EXID, destination UE ID/EXID>, if available. Applying a particular ATA relay 412 may include passing the source UE ID/EXID, a target UE ID/EXID, a message, a notification, and/or session handle to the ATA relay 412. Thereafter, ATA relay 412 may route the data to the target AS 216. For example, in FIG. 9, EXID system 214-1 may route the data to AS 216-2 (arrow 908).

Process 800 may further include providing the message, notification, and/or session handle to the destination UE 102 (block 812). For example, when target AS 216-2 receives the data, AS 216-2 may store the message, notification, and/or session handle in a buffer. When UE 102-2 establishes a session with or connects to AS 216-2, AS 216-2 may provide the notification, message, and/or session handle to UE 102-2 or corresponding target applications 302 on UE 102-2 (arrow 910). UE 102-2 or the application 302 on UE 102-2 may receive the data.

FIG. 9 depicts only a single communication from within EXID system 214-1 to AS 216-2 as a consequence of applying ATA relay 412. However, in practice, because there may be many pairs of <source UE ID/EXID, target UE ID/EXID> and <source UE ID/EXID, destination UE ID/EXID>, many ATA relays 412 in EXID system 214 may forward many copies of messages, notifications, or session handles to different target ASs 216, from which target applications 302 may pick up the data.

In some implementations, EXID system 214 may be configured to prevent flooding all target applications 302 on the destination UE 102 with multiple copies of the same message, notification, or session handle from the source UE 102/application 302. In such implementations, EXID system 214 may select only one EXID or UE ID over other EXIDs or UE IDs based on criteria to maximize the chance of contacting the user. The criteria may include, for example, which of the target applications 302 is most often accessed by the user, the QoS associated with applications 302, etc.

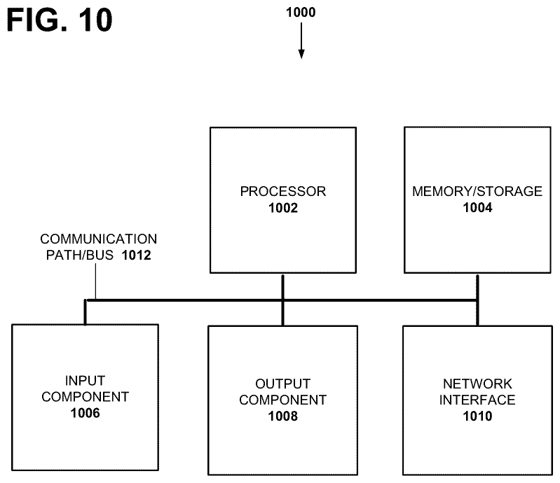

FIG. 10 depicts exemplary components of an exemplary network device 1000. Network device 1000 may correspond to or be included in any of the devices and/or components illustrated in FIGS. 1-5, 7, and 9 (e.g., UE 102, access network 204, core network 206, external network 208, access station 210, EXID system 214, AS 216, etc.). In some implementations, network devices 1000 may be part of a hardware network layer on top of which other network layers and network functions (NFs) may be implemented.

As shown, network device 1000 may include a processor 1002, memory/storage 1004, input component 1006, output component 1008, network interface 1010, and communication path 1012. In different implementations, network device 1000 may include additional, fewer, different, or different arrangement of components than the ones illustrated in FIG. 10. For example, network device 1000 may include line cards, switch fabrics, modems, etc.

Processor 1002 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1000 and/or executing programs/instructions.

Memory/storage 1004 may include static memory, such as read only memory (ROM), and/or dynamic memory, such as random access memory (RAM), or onboard cache, for storing data and machine-readable instructions (e.g., programs, scripts, etc.). Memory/storage 1004 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1004 may be external to and/or removable from network device 1000. Memory/storage 1004 may include, for example, a Universal Serial Bus (USB) memory stick, a dongle, a hard disk, off-line storage, a Blu-Ray® disk (BD), etc. Memory/storage 1004 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1006 and output component 1008 may provide input and output from/to a user to/from network device 1000. Input/output components 1006 and 1008 may include a display screen, a keyboard, a mouse, a speaker, a microphone, a camera, a DVD reader, USB lines, and/or other types of components for obtaining, from physical events or phenomena, to and/or from signals that pertain to network device 1000.

Network interface 1010 may include a transceiver (e.g., a transmitter and a receiver) for network device 1000 to communicate with other devices and/or systems. For example, via network interface 1010, network device 1000 may communicate over a network, such as the Internet, an intranet, cellular, a terrestrial wireless network, a satellite-based network, optical network, etc. Network interface 1010 may include a modem, an Ethernet interface to a LAN, and/or an interface/connection for connecting network device 1000 to other devices.

Communication path or bus 1012 may provide an interface through which components of network device 1000 can communicate with one another.

Network device 1000 may perform the operations described herein in response to processor 1002 executing software instructions stored in a non-transient computer-readable medium, such as memory/storage 1004. The software instructions may be read into memory/storage 1004 from another computer-readable medium or from another device via network interface 1010. The software instructions stored in memory/storage 1004, when executed by processor 1002, may cause processor 1002 to perform one or more processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, the term “external identifier” or EXID may refer to an alpha-numeric identifier. An EXID may include one or more components, one of which is a domain name. Examples of EXID include user-id@blah.com, “stewart.crash.com,” “hula.media.smart.com, where the domain names are “blah.com,” “crash.com,” and “smart.com,” respectively. An EXID may be qualitatively different from other IDs that are associated with broadband wireless communications, such as a MSISDN, an IMSI, an IMEI, a SUPI, or a SUCI. An EXID may also be qualitatively different from an IP address, which may be used to route IP packets. An EXID may identify a user of application 302, an application 302, an endpoint of communication, an account (e.g., an email account), etc. If an EXID identifies an application or a device (e.g., a logical or physical location in a network), the EXID may be associated with an IP address. If an EXID is associated with an IP address via Domain Name System (DNS) servers, the EXID may be used to lookup the corresponding IP address via the DNS servers. The corresponding IP address may be used for routing IP packets. In general, an EXID and an IP address may not be used interchangeably and may not be substituted for one another (e.g., an EXID and the corresponding IP address are not equivalent).

In addition, the term “Protocol Data Unit (PDU) session” may refer to communications between a mobile device and another endpoint (e.g., a data network, a network slice, etc.). Depending on the context, the term “session” may refer to a session between applications or a PDU session. Additionally, depending on the context, the term “connection” may refer to a session, a PDU session, or another type of connection (e.g., a radio frequency link between a device and a base station).

In the above, while series of actions, messages, and/or signals, have been described with reference to FIGS. 6-9, the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor to:
receive, via a wireless connection, from an application server that provided a source external identifier to a source User Equipment device (UE), a routing request that includes data and an identifier for a destination UE;
identify, a target external identifier for the destination UE; and
route the data to a target application server that issued the target external identifier.

2. The device of claim 1, wherein the processor is further configured to:
receive a request, from the application server, to register the source external identifier; and
register the source external identifier.

3. The device of claim 1, wherein the processor is further configured to:
register information identifying a first network that includes the application server; and
register information identifying a second network that includes the target application server.

4. The device of claim 3, wherein the processor is further configured to:
synchronize a first database, which stores the source external identifier, in the first network to a second database, which stores the target external identifier, in the second network.

5. The device of claim 1, wherein the target application server is configured to:
provide the data to the destination UE when the destination UE connects to the target application server.

6. The device of claim 1, wherein the application server is configured to:
receive a request, from the source UE, to communicate with the destination UE; and
send a request, to the device, to route the data to the destination UE.

7. The device of claim 1, wherein the destination UE includes:
one or more external identifiers associated with applications that are hosted by the destination UE, wherein the one or more external identifiers include the target external identifier.

8. A method comprising:
receiving, via a wireless connection by a device from an application server that provided a source external identifier to a source User Equipment device (UE), a routing request that includes data and an identifier for a destination UE;
identifying, by the device, a target external identifier for the destination UE; and
routing, by the device, the data to a target application server that issued the target external identifier.

9. The method of claim 8, further comprising:
receiving, by the device, a request, from the application server, to register the source external identifier; and
registering, by the device, the source external identifier.

10. The method of claim 8, further comprising:
registering information identifying a first network that includes the application server; and
registering information identifying a second network that includes the target application server.

11. The method of claim 10, further comprising:
synchronizing a first database, which stores the source external identifier, in the first network to a second database, which stores the target external identifier, in the second network.

12. The method of claim 8, further comprising:
providing, by the target application server, the data to the destination UE when the destination UE connects to the target application server.

13. The method of claim 8, further comprising:
receiving, by the application server, a request, from the source UE, to communicate with the destination UE; and
sending, by the application server, a request, to the device, to route the data to the destination UE.

14. The method of claim 8, wherein the destination UE includes:
one or more external identifiers associated with applications that are hosted by the destination UE, wherein the one or more external identifiers include the target external identifier.

15. A non-transitory computer-readable medium, comprising processor-executable instructions, which when executed by a processor in a device, cause the processor to:
receive, via a wireless connection from an application server that provided a source external identifier to a source User Equipment device (UE), a routing request that includes data and an identifier for a destination UE;
identify a target external identifier for the destination UE; and
route the data to a target application server that issued the target external identifier.

16. The non-transitory computer-readable medium of claim 15, wherein the instructions further cause the processor to:
receive a request, from the application server, to register the source external identifier; and
register the source external identifier.

17. The non-transitory computer-readable medium of claim 15, wherein the instructions further cause the processor to:
register information identifying a first network that includes the application server; and
register information identifying a second network that includes the target application server.

18. The non-transitory computer-readable medium of claim 17, wherein the instructions further cause the processor to:
synchronize a first database, which stores the source external identifier, in the first network to a second database, which stores the target external identifier, in the second network.

19. The non-transitory computer-readable medium of claim 15, wherein the target application server is configured to:
provide the data to the destination UE when the destination UE connects to the target application server.

20. The non-transitory computer-readable medium of claim 15, wherein the application server is configured to:
receive a request, from the source UE, to communicate with the destination UE; and
send a request, to the device, to route the data to the destination UE.
